(19) United States
(12) Patent Application Publication
(10) Pub. No.: US 2024/0199788 A1
(43) Pub. Date: Jun. 20, 2024

(54) METHOD OF PRODUCING MORPHOLINE CATALYSTS FOR RIGID FOAM SYSTEMS AND USES THEREOF

(71) Applicant: Huntsman Petrochemical LLC, The Woodlands, TX (US)

(72) Inventors: Matthew T. Meredith, The Woodlands, TX (US); Jingjun Zhou, The Woodlands, TX (US)

(21) Appl. No.: 18/286,153

(22) PCT Filed: Mar. 28, 2022
(86) PCT No.: PCT/US2022/022138

§ 371 Date: Oct. 9, 2023

Related U.S. Application Data
(60) Provisional application No. 63/174,165, filed on Apr. 13, 2021.

(51) Int. Cl. C08G 18/20; C08G 18/22; C08G 18/24; C08J 9/14

(52) U.S. Cl. CPC C08G 18/2081; C08G 18/222; C08G 18/227; C08G 18/24; C08J 9/144; C08G 2110/0025; C08J 2203/142; C08J 2375/04

(57) ABSTRACT

A catalyst for use in a rigid foaming system including an isocyanate and a halogenated olefinic blowing agent is described and a process for creating a rigid foaming system thereof. The catalyst can include a morpholine ring and a central N-alkyl group.

### CROSS-REFERENCE TO RELATED APPLICATIONS

The present disclosure generally relates to a catalyst that is stable in a foam reaction system having a blowing agent. More specifically, the present disclosure relates to a polyurethane catalyst having one or more morpholine rings for use in a foaming system.

### FIELD

The present disclosure generally relates to a catalyst that is stable in a foam reaction system having a blowing agent. More specifically, the present disclosure relates to a polyurethane catalyst having one or more morpholine rings for use in a foaming system.

### BACKGROUND

Polyurethane (PU) foams can be useful for insulation including, without limitation, for appliances and buildings, due to their low thermal conductivity and dimensional stability at low densities. Polyurethane foams are conventionally prepared by reacting one or more polyols, sometimes in the form of a polyol resin, with an isocyanate in the presence of a blowing agent. Catalysts are frequently used to assist in the formation of such foam systems. Halogenated olefinic blowing agents are commonly used in polyurethane foam applications in lieu of more environmentally harmful blowing agents. However, the addition of amine catalysts into such polyol systems in the presence of a halogenated olefinic blowing agent can result in the degradation and failure of the foaming blend due to unwanted reactions between the amines, blowing agents, and surfactants. Various amines have been tested in attempt to create more stable systems having sufficient reactivity, but these amines tend to be slower acting catalysts. There are very few catalysts available which are stable within foam systems and capable of promoting the isocyanate and water reaction (e.g., blowing). At least one catalyst capable of promoting such foam system is dimorpholinodiethylether (DMDEE). While DMDEE is stable in the presence of the reactive olefinic blowing agent, is a slow acting catalyst.

Faster acting polyurethane amine catalysts that are typically used can contain N-alkyl groups, particularly C1-C4 alkyl groups. The small n-alkyl groups can minimize steric hindrance around the amine group, allowing faster catalysis of the polyurethane foam reactions. However, such catalysts can cause rapid degradation of polyol resin blends containing halogenated olefinic blowing agents making them unstable when reacted.

Additionally, amine catalysts which are stable in the presence of isocyanates are rare due to the extreme reactive nature of the isocyanate moiety. The presence of an amine in an isocyanate can catalyze the reaction of the isocyanates with each other to form isocyanurates, uretidiones, carbodiimides, and uretoneimines. Specifically, in the case of di- or tri-isocyanates typically used in industrial applications, this leads to polymerization of the isocyanate with itself, rendering it useless.

Despite the state of the art, there is a continuous need for the development of a fast catalyst that is stable in a polyurethane foam system.

### BRIEF DESCRIPTION OF THE DRAWINGS

A full understanding of the invention can be gained from the following description of certain embodiments of the invention when read in conjunction with the accompanying drawings in which:

FIG. 1 is a graph illustrating the reactivity analysis of two catalysts.

FIGS. 2A-2B are graphs illustrating the results of a stability analysis of a foam system over a period of six (6) weeks.

FIGS. 3A-3B are graphs illustrating the results of a stability analysis of a foam system including co-catalysts over a period of six (6) weeks.

### DETAILED DESCRIPTION

Before explaining aspects of the present disclosure in detail, it is to be understood that the present disclosure is not limited in its application to the details of construction and the arrangement of components or steps or methodologies set forth in the following description. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

If the specification states a component or feature “may,” “can,” “could,” or “might” be included or have a characteristic, that particular component or feature is not required to be included or have the characteristic.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

In addition, the phrase “at least one of X, Y, and Z” will be understood to include X alone, Y alone, and Z alone, as well as any combination of X, Y, and Z. Likewise, the phrase “at least one of X and Y” will be understood to include X alone, Y alone, as well as any combination of X and Y. Additionally, it is to be understood that the phrase “at least one of” can be used with any number of components and have the similar meanings as set forth above.

The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the term “and combinations thereof” when used with the phrase “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the terms “% by weight”, “wt %”, “weight percentage”, or “percentage by weight” are used interchangeably.

Rigid foam systems produced by the process described herein can be used as an insulation material in various fields including, without limitation, construction (spray foam), appliances (refrigerators, water heaters, etc.), boardstock insulation, pour-in-place metal panels, and high-density rigid structural foams. The rigid foam system can include at least one or more polyhydroxyl compounds, one or more blowing agents, and one or more catalysts. Various additives can be included based on the desired final use of the foam.

The present invention is directed to an amine catalyst containing one or more morpholine groups and one central n-alkyl group for use in rigid foam systems and methods of use thereof. Such rigid foams can include rigid polyurethane (PU) and polyisocyanurate (PIR) foams produced either in a one-component reaction or a two-component reaction. Such systems can be created using either one-component or two-component systems. Two component systems can include a first stream including an isocyanates and a blowing agent, while a second stream can include at least one or more polyhydroxyl compounds and a catalyst. The two streams are then combined to generate the foamed system.

On the contrary, one component systems can include mixing amines and isocyanates in the same container to provide a blend which does not require additional mixing of streams. Such one-component systems can be made using one-shot processes including, without limitation, using reaction injection molding, high pressure pour methods, low pressure pour methods, open molds, closed molds, and pour-in-place applications. The reaction mixture can form a foamed system upon contacting the surface of the mold.

Such foam systems can include one-component polyurethane adhesives, foams, and coatings, where isocyanates, polyhydroxyl compounds, catalysts, blowing agents, and other additives are all combined into a single mixture. Such systems can include halogenated olefinic blowing agents, requiring such amines to be stable with both isocyanates and the reactive blowing agent. Very few catalysts are stable in such systems, one of which is DMDEE which maintains stability with steric hinderance and electronically deactivated morpholine rings. However, DMDEE is a slow acting catalyst.

In at least one example, the one or more polyhyroxyl compounds can be combined with other elements to create a polyol resin. Polyol resins can include polyhydroxyl compounds having certain equivalent weights, functionalities, and viscosities, one or more blowing agents, and one or more catalysts. A stable, rigid polyurethane or polyisocyanurate foam can be created by mixing one or more polyol resins with an isocyanate compound. The one or more catalysts of the polyol resin composition typically is present to speed up the isocyanate-polyhydroxyl compound reaction. As discussed above, commonly used catalysts, including, without limitation, DMDEE, are slow-acting catalysts. Disclosed herein are fast-acting catalysts that are stable in the presence of isocyanates and halogenated olefinic blowing agents for the creation of polyurethane or polyisocyanurate foams. As indicated above, catalysts used for one-component materials such as spray foam insulation, pour-in-place building panels and cavity-filled appliances such as refrigerators and water heaters require a faster acting catalyst than those presently available on the market. The catalyst described herein can include one or more morpholine groups and a central n-alkyl group. In at least one example, the catalyst can be represented by formula (I):

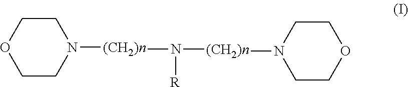

where R is a linear or branched alkyl having from 1 to 4 carbon atoms and n=2-4.

In at least one example, n can be 2, and the catalyst can be represented by formula (II), below:

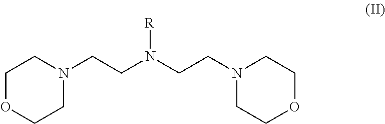

where R is an alkyl having from 1 to 4 carbon atoms.

Catalysts having the structure of formula (I) have been found to provide enhanced reactivity over catalysts which are presently used in the field including, without limitation, dimorpholinodiethylether (DMDEE, commercially available as JEFFCAT® DMDEE). The catalysts as described herein provide stability levels comparable to those currently used in polyurethane or polyisocyanurate foams while providing a faster acting catalyst.

Catalysts as described herein can be used in rigid foaming systems including, without limitation, foam systems. It is known in the art that the process for producing a rigid or semi-rigid polyurethane and polyisocyanurate foams by reacting one or more isocyanate(s) with one or more polyhydroxyl compound(s) (e.g., in the form of a polyol resin) in the presence of one or more blowing agent(s) one or more catalyst(s) and one or more surfactant(s). The catalyst can be present in the foam system in an amount ranging from about 0.1 wt % to about 20 wt % based on the total weight of the polyol resin blend.

In at least one example, multiple catalysts can be present. Such co-catalysts can include, without limitation, a metal co-catalyst (including without limitation a tin catalyst, a bismuth catalyst, and a zinc catalyst), and/or one or more amine co-catalysts, including, without limitation, 1,2-dimethylimidazole, dimorpholinodiethylether (commercially available as JEFFCAT® DMDEE), N¹-(2-(dimethylamino)ethyl)-N¹,N²,N²-trimethylethane-1,2-diamine (commercially available as JEFFCAT® PMDETA), 2,2′-oxybis(N, N-dimethylethan-1-amine) (commercially available as JEFFCAT® ZF-20), 2-((2-(2-(dimethylamino)ethoxy)ethyl) (methyl)amino)ethan-1-ol (commercially available as JEFFCAT® ZF-10), 2-((2-(dimethylamino)ethyl)(methyl)amino)ethan-1-ol (commercially available as JEFFCAT® Z-110), 2-(2-(dimethylamino)ethoxy)ethan-1-ol (commercially available as JEFCAT® ZR-70), 1-(bis(3-(dimethylamino)propyl)amino)propan-2-ol (commercially available as JEFFCAT® ZR-40), 2-(2-(dimethylamino)ethoxy)-N-(2-(2-(dimethylamino)ethoxy)ethyl)-N-methylethan-1-amine (commercially available as JEFFCAT® LE-30), 1,1′-((3-(dimethylamino)propyl)azanediyl)bis(propan-2-ol), available as JEFFCAT® DPA, N¹,N¹-bis(3-(dimethylamino)propyl)-N³,N³-dimethylpropane-1,3-diamine (commercially available as JEFFCAT® Z-80), 3,3′,3″-(1,3,5-triazinane-1,3,5-triyl)tris(N,N-dimethylpropan-1-amine) (commercially available as JEFFCAT® TR-90), and N¹-(3-(dimethylamino)propyl)-N³,N³-dimethylpropane-1,3-diamine (commercially available as JEFFCAT® Z-130). Products under the JEFFCAT® name are available from Huntsman Corporation. The amine co-catalysts can be used in their pure form or as reaction products with acids to increase their stability with the blowing agents.

In at least one example, the one or more polyhydroxyl compounds (also referred to herein as “polyols”) that can be used in a foam system having the catalyst described herein can include, without limitation, polyoxyalkylene polyether polyols, including conventional polyoxyalkylene polyether polyols, as well as the polymer modified polyoxyalkylene polyether polyols. Suitable polyester polyols include those obtained, for example, from polycarboxylic acids and polyhydricalcohols. A suitable polycarboxylic acid may be used as oxalic acid, malonic acid, succinic acid, glutaric acid, adipic acid, pimelic acid, suberic acid, azelaic acid, sebacic acid, brassylie acid, thapsic acid, maleic acid, fumaric acid, glutaconic acid, α-hydromuconic acid, β-hydromuconic acid, α-butyl-α-ethyl-glutaric acid, α,β-diethylsuccinic acid, isophthalic acid, therphthalic acid, phthalic acid, hemimellitic acid, and 1,4-cyclohexanedicarboxylic acid, A suitable polyhydric alcohol may be used such as ethylene glycol, propylene glycol, dipropylene glycol, trimethylene glycol, 1,2-butanediol, 1,5-pentanediol, 1,6-hexanediol, 1,7-heptanediol, hydroquinone, resorcinol glycerol, glycerine, 1,1,1-trimethylol-propane, 1,1,1-trimethylolethane, pentaerythritol, 1,2,6-hexanetriol, α-methyl glucoside, sucrose, and sorbitol. Also included within the term “polyhydric alcohol” are compounds derived from phenol such as 2,2-bis(4-hydroxyphenyl)-propane, commonly known as Bisphenol A. In at least one example, the polyhydroxyl compound(s) can be present in an amount ranging from about 40 wt % to about 80 wt % based on the total weight of the polyol resin blend.

The one or more blowing agents can be selected from physically active blowing agents and chemically active blowing agents. Physical blowing agents produce their blowing effect by physical expansion rather than by chemical reaction, as with chemical blowing agents. Any suitable blowing agent can be used including, without limitation, water, organic acids that produce CO₂ and/or CO, hydrocarbons, fluorocarbons, chlorocarbons, chlorofluorocarbons, hydrochlorofluorocarbons, halogenated hydrocarbons, halogenated olefinic blowing agents, ethers, halogenated ethers, esters, alcohols, aldehydes, ketones, pentafluorobutane, pentafluoropropane, hexafluoropropane, heptafluoropropane, trans-1,2dichloroethylene, methylal, methyl formate, 1-chloro-1,2,2,2-tetrafluoroethane (HCFC-124), 1,1-dichloro-1-fluoroethane (HCFC-141b), 1,1,1,2-tetrafluoroethane (HFC-134a), 1,1,2,2-tetrafluoroethane (HFC-134), 1-chloro 1,1-difluoroethane (HCFC-142b), 1,1,1,3,3-pentafluorobutane (HFC-365mfc), 1,1,1,2,3,3,3-heptafluoropropane (HFC-227ea), trichlorofluoromethane (CFC-11), dichlorodifluoromethane (CFC-12), dichlorofluoromethane (HCFC-22), 1,1,1,3,3,3-hexafluoropropane (HFC-236fa), 1,1,1,2,3,3-hexafluoropropane (HFC-236e), 1,1,1,2,3,3,3-heptafluoropropane (HFC-227ea), difluoromethane (HFC-32), 1,1-difluoroethane (HFC-152a), 1,1,1,3,3-pentafluoropropane (HFC-245fa), butane, isobutane, normal pentane, isopentane, cyclopentane, or combinations thereof. The amount of blowing agent present in the foam system can be dependent upon the desired density of the resulting foam. In at least one example, the blowing agent can be present in the foam system in an amount ranging from about 3 wt % to about 20 wt % with respect to the total weight of the polyol resin blend.

Surfactants which can be used in the polyol resin include, without limitation, silicone polymers typically with pendant polyether side-chains, such as those in the VORASURF® line of products manufactured by Dow Chemical. In at least one example, the surfactant can be present in the foam system in an amount ranging from about 0.5 wt % to 5 wt % with respect to the total weight of the polyol resin blend.

The isocyanates compatible with the present catalyst include, without limitation, diisocyanates and polyisocyanurates. In at least one example, RUBINATE® M polymer MDI, which is a common polyisocyanate, can be used in this type of application.

Alkylamino-containing molecules, in particular methylamino-containing molecules, are generally unstable when used in foaming systems which include halogenated olefinic blowing agents. It was surprisingly determined that the catalysts having formula (I) as disclosed herein provided an improved stability in systems using such blowing agents. Additionally, it was determined that polyol resin blends containing halogenated olefinic blowing agents and the presently disclosed catalysts provide increased activity as compared to catalysts which are presently used in the industry including, without limitation, DMDEE, while still retaining excellent stability.

### EXAMPLES

Examples are provided below. However, the present disclosure is to be understood to not be limited in its application to the specific experiments, results, and laboratory procedures disclosed herein below. Rather, the Examples are simply provided as one of various embodiments and are meant to be exemplary and not exhaustive.

An exemplary foam system was prepared including a polyol resin having a plurality of polyhydroxyl compounds. The polyol resin blend for use in closed cell spray foam was prepared having a composition as shown in Table 1.

TABLE 1

| Molecule | Weight Percentage |
|---|---|
| Terol ® 925 | 52.3 |
| JEFFOL ® R-425-X | 10 |
| JEFFOL ® SG-522 | 7.9 |
| SAYTEX ® RB-79 | 6.8 |
| TCPP | 11 |
| Silicone surfactant | 1 |
| HFO 1233zd(E) (Solstice ® LBA) | 11 |

Catalysts and water were added to the above polyhydroxyl compound blend and mixed together. Subsequently, a diisocyanate (e.g. RUBINATE® M polymeric MDI) was added to the mixture and foams were created in a plurality of cups using an overhead mixer. Foam reactivity profiles were measured in a manner similar to the procedure outlined in ASTM D7487-13.

### Exemplary Catalyst Synthesis

Hydroxyethylmorpholine was reductively aminated in a continuous reactor and the resulting crude product was distilled to give a mixture of N-(2-aminoethyl)morpholine and bis-morpholineoethylamine. A first portion of the bis-morpholinoethylamine was then further reacted with formaldehyde under standard catalytic hydrogenation conditions to yield compound A, shown below. A second portion of the bis-morpholinoethylamine was further reacted with acetone under standard catalytic hydrogenation conditions to yield compound B, shown below. DMDEE is provided for comparison, the structure of DMDEE is provided below as compound C.

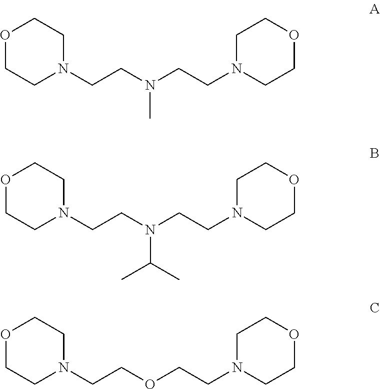 [SMILES: CN(CCN1CCOCC1)CCN1CCOCC1 ; CC(C)N(CCN1CCOCC1)CCN1CCOCC1 ; C1CN(CCOCCN2CCOCC2)CCO1]

The following comparative and experimental examples were performed to evaluate the morpholine catalysts and methods of making them as described herein:

### Example 1: Reactivity Analysis

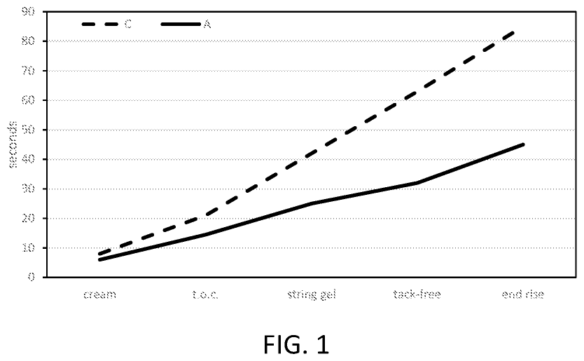

In separate containers, a 1.8% water and 5% of either Catalyst A and Catalyst C, as defined above, were added to a polyhydroxyl compound blend and evaluated for reactivity. The results of the reactivity analysis are provided in the graph of FIG. 1. As illustrated, the reaction including Catalyst A proved to be much faster on both the front and back-end of the polyurethane foam reaction.

### Example 2: Catalyst Stability

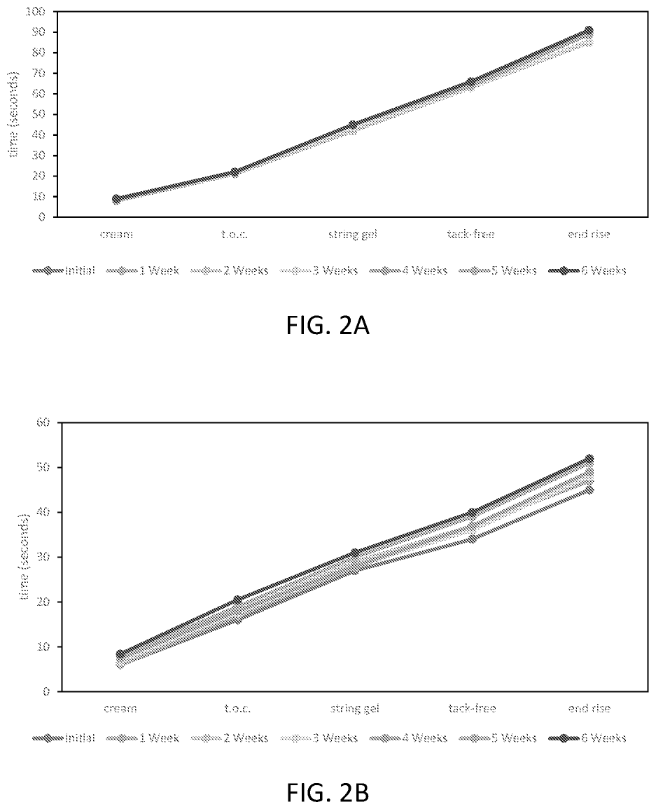

Catalysts A and C were evaluated to determine stability in the presence of HFO 1233zd(E) in the same example formulations provided in Example 1. The polyol resin blends including the water and catalyst were stored in an oven at 50° C. for a period of 6 weeks. A sample was taken from each formulation once per week and the reactivity in a foam was evaluated. The results of the stability evaluation of the Catalyst C formulation and the Catalyst A formulation are provided in FIGS. 2A and 2B, respectively.

### Example 3: Co-Catalyst Stability

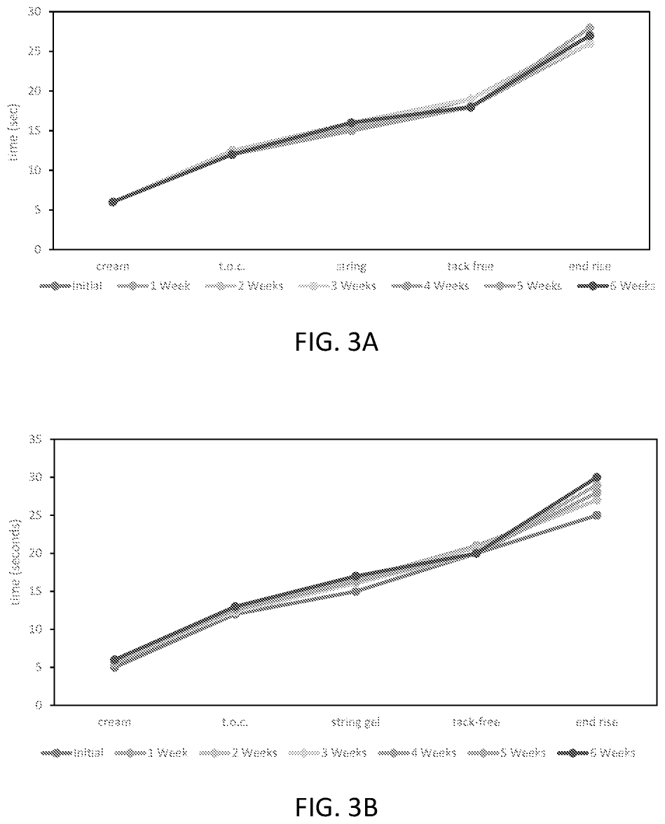

Catalysts such as those described herein are typically used as co-catalysts in spray foam systems, the same stability test as indicated in Example 2 was performed using 1,2-dimethyimidazole as a co-catalyst to the formulations having Catalyst A and Catalyst C. For the purpose of this example, 3 wt % of Catalyst A or C was used in the same system as described in Example 1, having a 2 wt % of 1,2-dimethylimidazole (supplied as JEFCAT® H-73) added thereto. The same stability test as described above was performed on each of the co-catalyst samples. The results of the stability test are provided for the formulation including Catalyst C and Catalyst A in FIGS. 3A and 3B, respectively.

From the above description, it is clear that the present disclosure is well adapted to carry out the object and to attain the advantages mentioned herein as well as those inherent in the present disclosure. While exemplary embodiments of the present disclosure have been described for the purposes of the disclosure, it will be understood that numerous changes may be made which will readily suggest themselves to those skilled in the art which can be accomplished without departing from the scope of the present disclosure and the appended claims.

What is claimed is:

1. A polyol resin blend comprising:
at least one polyhydroxyl compound, at least one halogenated olefinic blowing agent, and a catalyst having the structure: 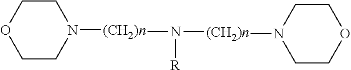
where n=2-4 and R=C₁-C₄ linear or branched alkyl.

2. The polyol resin blend of claim 1, further comprising one or more co-catalysts.

3. The composition of claim 1, further comprising a metal co-catalyst selected from the group of tin catalysts, bismuth catalysts, and zinc catalysts.

4. A polyurethane foam formed by reacting the polyol resin blend of claim 1 with a polyisocyanate.

5. A process for producing a rigid polyurethane foam comprising:
mixing a polyisocyanate with a polyol resin blend, the polyol resin blend containing at least one polyhydroxyl compound, a halogenated olefinic blowing agent, and an amine catalyst having the structure: 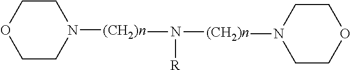
where n=2-4 and R=C₁-C₄ linear or branched alkyl; and
foaming the polyisocyanate and polyol resin blend mixture,
wherein the amine catalyst is present in an amount between about 0.1 wt % to about 20 wt % with respect to the total weight of the polyol resin blend.

6. The process of claim 5, further comprising one or more co-catalysts.

7. The process of claim 6, wherein the one or more co-catalysts is selected from the group comprising 1,2-dimethylimidazole, dimorpholinodiethylether, N¹-(2-(dimethylamino)ethyl)-N¹,N²,N²-trimethylethane-1,2-diamine, 2,2′-oxybis(N,N-dimethylethan-1-amine), 2-((2-(2-(dimethylamino)ethoxy)ethyl) (methyl)amino)ethan-1-ol, 2-((2-(dimethylamino)ethyl) (methyl)amino)ethan-1-ol, 2-(2-(dimethylamino)ethoxy)ethan-1-ol, 1-(bis(3-(dimethylamino)propyl)amino)propan-2-ol, 2-(2-(dimethylamino)ethoxy)-N-(2-(2-(dimethylamino)ethoxy)ethyl)-N-methylethan-1-amine, 1,1′-((3-(dimethylamino)propyl)azanediyl)bis(propan-2-ol), N¹,N¹-bis(3-(dimethylamino)propyl)-N³,N³-dimethylpropane-1,3-diamine, 3,3′,3″-(1,3,5-triazinane-1,3,5-triyl)tris(N,N-dimethylpropan-1-amine), and N¹-(3-(dimethylamino)propyl)-N³,N³-dimethylpropane-1,3-diamine.

8. The process of claim 6, wherein the one or more co-catalysts is a metal co-catalyst selected from the group of tin catalysts, bismuth catalysts, and zinc catalysts.
